(19) United States
(12) Patent Application Publication
(10) Pub. No.: US 2026/0127276 A1
(43) Pub. Date: May 7, 2026

(54) COMMUNICATION SECURITY VIA CONTEXT-BASED MESSAGE VALIDATION AND MALICIOUS CONTENT DETECTION

(71) Applicant: International Business Machines Corporation, Armonk, NY (US)

(72) Inventors: Jignesh Karia, Thane (IN); Mukundan Sundararajan, Bangalore (IN); Pankaj Satyanarayan Dayama, Bangalore (IN); SHILPA SHETTY, Sydney (AU); NEHA SHAH, Kolkata (IN)

(21) Appl. No.: 18/937,102

(22) Filed: Nov. 5, 2024

(51) Int. Cl. G06F 21/55

(52) U.S. Cl. CPC G06F 21/554; G06F 2221/034

(57) ABSTRACT

According to one embodiment of the present invention, a system for validating a message comprises one or more memories and at least one processor coupled to the one or more memories. The system generates a template from a message received over a network, and the template indicates template task contexts and template entity contexts. The template is determined as associated with a valid template of a sender indicated in the message. A concavity value representing an amount of sensitive information requested by the message is generated based on differences between task contexts and entity contexts indicated in the message and the template task contexts and template entity contexts. An alert is triggered based on the concavity value. Embodiments of the present invention further include a method and computer program product for validating a message in substantially the same manner described above.

### BACKGROUND

### 1. Technical Field

Present invention embodiments relate to communication security, and more specifically, to determining an amount of sensitive information requested by a message to alert a user of potential privacy or security breaches and mitigate fraudulent communication attacks.

### 2. Discussion of the Related Art

Entities (e.g., individuals, businesses, institutions, etc.) communicate with others over a network through various forms of messaging, including short message service (SMS) text message, email, chat, etc. The messages may include requests for a recipient to provide sensitive information (e.g., personal information, account details, etc.). Malicious actors, pretending to be trusted entities, send fraudulent messages to deceive recipients into sharing sensitive information, thereby compromising data privacy and security of the recipients. Conventional approaches use rule-based heuristics and string comparison algorithms to identify malicious content in a message. However, these conventional approaches rely on predetermined indicators of fraud (e.g., message contains poor grammar or urges immediate action) and do not effectively leverage contextual information in a message to dynamically detect malicious content, thereby exposing message recipients to privacy or security breaches.

### SUMMARY

According to one embodiment of the present invention, a system for validating a message comprises one or more memories and at least one processor coupled to the one or more memories. The system generates a template from a message received over a network, and the template indicates template task contexts and template entity contexts. The template is determined as associated with a valid template of a sender indicated in the message. A concavity value representing an amount of sensitive information requested by the message is generated based on differences between task contexts and entity contexts indicated in the message and the template task contexts and template entity contexts. An alert is triggered based on the concavity value. Embodiments of the present invention further include a method and computer program product for validating a message in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a flow diagram of validating a message according to an embodiment of the present invention.

FIG. 3 is a procedural flowchart of validating the content of a message according to an embodiment of the present invention.

FIG. 4A is a flow diagram of generating a template from a message according to an embodiment of the present invention.

FIG. 4B is a flow diagram of fine-tuning a template generation model according to an embodiment of the present invention.

FIG. 5 illustrates exemplary message-template pairs for transactional or service messages according to an embodiment of the present invention.

FIG. 6A is a flow diagram of validating a message containing a uniform resource locator (URL) according to an embodiment of the present invention.

FIG. 6B is a flow diagram of verifying user consent for receiving a message from a sender according to an embodiment of the present invention.

FIG. 7 is a block diagram of a system for verifying user consent for receiving a SMS message from a sender according to an embodiment of the present invention.

FIG. 8 illustrates a graph for determining a concavity value for a message according to an embodiment of the present invention.

### DETAILED DESCRIPTION

Entities (e.g., individuals, businesses, institutions, etc.) communicate with others over a network through various forms of messaging, including short message service (SMS) text message, email, chat, etc. The messages may include requests for a recipient to provide sensitive information (e.g., personal information, account details, etc.). Malicious actors, pretending to be trusted entities, send fraudulent messages to deceive recipients into sharing sensitive information, thereby compromising data privacy and security of the recipients. Conventional approaches use rule-based heuristics and string comparison algorithms to identify malicious content in a message. However, these conventional approaches rely on predetermined indicators of fraud (e.g., message contains poor grammar or urges immediate action) and do not effectively leverage contextual information in a message to dynamically detect malicious content, thereby exposing message recipients to privacy or security breaches.

Accordingly, an embodiment of the present invention validates a message to alert a user of malicious content (without revealing sensitive information associated with the user). The embodiment of the present invention leverages machine learning techniques to generate a template of the message. The template, along with a message header, are matched against templates and message headers associated with a valid sender to determine whether the message is sent by a trusted entity. The embodiment of the present invention further compares counts of words/phrases representing entity contexts and task contexts indicated in the message and words/phrases representing template entity contexts and template task contexts of a validated template to discern the intent and trust level associated with the message. This provides dynamic detection of malicious content in a message without revealing the content of the message, which may include sensitive information associated with the user.

Typically, a user may receive a message that appears to be from a trusted entity (e.g., retailers, banks, etc.). An embodiment of the present invention validates a message to determine whether the message is from a trusted entity and detect malicious content that attempts to deceive the user into providing sensitive information. For example, a user may receive a SMS message that appears to be from a well-known retailer and contains a URL about an upcoming sale. The user may desire to determine whether the message is legitimate. In particular, the user may desire to know whether clicking the URL will lead to any privacy or security breaches. The embodiment of the present invention generates a template from the message and determines that the template is associated with a valid template of a sender indicated in the message. The embodiment of the present invention further generates a concavity value to represent an amount of sensitive information requested by the message and triggers an alert based on the concavity value.

An embodiment of the present invention validates a message to detect malicious content based on contexts in the message. One or more sentences from the message are extracted based on one or more part-of-speech tags associated with tokens representing the message. A template of the message is compared to the one or more sentences to generate an entity contextual ratio and a task contextual ratio. The entity contextual ratio is a ratio of a first number of entity contexts in the message and a second number of template entity contexts. The task contextual ratio is a ratio of a first number of task contexts in the message and a second number of template task contexts. An alignment score indicative of a level of alignment between the template and the message is determined. The alignment score is a ratio of the entity contextual ratio and the task contextual ratio. The concavity value is determined based on the alignment score and an aggregation value for the task contexts of the message. The aggregation value represents a number of phrases in the message indicative of one or more tasks expressed by the message.

According to an aspect of the invention, there is provided a method of validating a message. At least one processor generates a template from a message received over a network and the template indicates template task contexts and template entity contexts. The at least one processor determines that the template is associated with a valid template of a sender indicated in the message. The at least one processor generates a concavity value, based on differences between task contexts and entity contexts indicated in the message and the template task contexts and template entity contexts, to represent an amount of sensitive information requested by the message. The at least one processor triggers an alert based on the concavity value.

This provides enhanced privacy protection by dynamically detecting and alerting a user of a malicious message intended to deceive a user into supplying sensitive information based on contexts indicated in the message. Further, a present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, generating the template comprises: tokenizing the message to generate one or more tokens, tagging the one or more tokens with one or more part-of-speech tags each indicating a part of speech, determining, via a named entity recognition model, one or more recognized entities based on the one or more tokens, and performing pattern matching on the one or more recognized entities to generate the template. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, determining that the template is associated with a valid template comprises generating a hash value for the template, and identifying a registered template for the sender that hashes to the hash value and corresponds to a message header of the message to indicate the template is associated with the valid template of the sender. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, generating the concavity value comprises extracting one or more sentences from the message based on the one or more part-of-speech tags, comparing the template and the one or more sentences to generate an entity contextual ratio and a task contextual ratio, determining an alignment score indicative of a level of alignment between the template and the message, wherein the alignment score is a ratio of the entity contextual ratio and the task contextual ratio, and determining the concavity value based on the alignment score and an aggregation value for the task contexts of the message. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, the entity contextual ratio is a ratio of a first number of entity contexts in the message and a second number of template entity contexts, and the task contextual ratio is a ratio of a first number of task contexts in the message and a second number of template task contexts. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, the aggregation value represents a number of phrases in the message indicative of one or more tasks expressed by the message. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, the named entity recognition model includes a transformer that is iteratively fine-tuned based on a plurality of historical messages and corresponding templates. This provides enhanced privacy protection by producing a template that accurately reflects the content of the message, thus increasing the accuracy of malicious content detection.

In embodiments, the at least one processor further determines that a message header indicates consent to receive the message. The at least one processor parses the message to determine that a uniform resource locator (URL) is included in the message. The at least one processor determines that a domain name of the URL matches a list of domain names registered by the sender. This provides enhanced privacy protection by verifying whether the uniform resource locator contained in the message is associated with a trusted sender and detecting malicious content intended to deceive a user into providing sensitive information through a fraudulent uniform resource locator.

In embodiments, the message includes a short message service text message received at a mobile device. The present invention embodiment leverages task contexts and entity contexts indicated in the short message service message to accurately discern the intent of the short message service message without revealing sensitive information associated with the user. This provides enhanced privacy protection by detecting malicious short message service messages while maintaining the confidentiality of the user.

According to an aspect of the invention, there is provided a system for validating a message comprising one or more memories, and at least one processor coupled to the one or more memories. The at least one processor generates a template from a message received over a network and the template indicates template task contexts and template entity contexts. The at least one processor determines that the template is associated with a valid template of a sender indicated in the message. The at least one processor generates a concavity value, based on differences between task contexts and entity contexts indicated in the message and the template task contexts and template entity contexts, to represent an amount of sensitive information requested by the message. The at least one processor triggers an alert based on the concavity value.

This provides enhanced privacy protection by dynamically detecting and alerting a user of a malicious message intended to deceive a user into supplying sensitive information based on contexts indicated in the message. Further, a present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the system, generating the template comprises tokenizing the message to generate one or more tokens, tagging the one or more tokens with one or more part-of-speech tags each indicating a part of speech, determining, via a named entity recognition model, one or more recognized entities based on the one or more tokens, and performing pattern matching on the one or more recognized entities to generate the template. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the system, determining that the template is associated with a valid template comprises generating a hash value for the template, and identifying a registered template for the sender that hashes to the hash value and corresponds to a message header of the message to indicate the template is associated with the valid template of the sender. The present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the system, generating the concavity value comprises extracting one or more sentences from the message based on the one or more part-of-speech tags, comparing the template and the one or more sentences to generate an entity contextual ratio and a task contextual ratio, determining an alignment score indicative of a level of alignment between the template and the message, wherein the alignment score is a ratio of the entity contextual ratio and the task contextual ratio, and determining the concavity value based on the alignment score and an aggregation value for the task contexts of the message. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the system, the entity contextual ratio is a ratio of a first number of entity contexts in the message and a second number of template entity contexts, and the task contextual ratio is a ratio of a first number of task contexts in the message and a second number of template task contexts. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the system, the aggregation value represents a number of phrases in the message indicative of one or more tasks expressed by the message. The present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, the named entity recognition model includes a transformer that is iteratively fine-tuned based on a plurality of historical messages and corresponding templates. This provides enhanced privacy protection by producing a template that accurately reflects the content of the message, thus increasing the accuracy of malicious content detection.

In embodiments of the system, the at least one processor further determines that a message header indicates consent to receive the message. The at least one processor parses the message to determine that a uniform resource locator (URL) is included in the message. The at least one processor determines that a domain name of the URL matches a list of domain names registered by the sender. This provides enhanced privacy protection by verifying whether the uniform resource locator contained in the message is associated with a trusted sender and detecting malicious content intended to deceive a user into providing sensitive information through a fraudulent uniform resource locator.

According to an aspect of the invention, there is provided a computer program product for validating a message. The computer program product comprises one or more computer readable storage media having program instructions collectively stored on the one or more computer readable storage media. The program instructions executable by at least one processor to cause the at least one processor to generate a template from a message received over a network and the template indicates template task contexts and template entity contexts. The program instructions cause the at least one processor to determine that the template is associated with a valid template of a sender indicated in the message. The program instructions cause the at least one processor to generate a concavity value, based on differences between task contexts and entity contexts indicated in the message and the template task contexts and template entity contexts, to represent an amount of sensitive information requested by the message. The program instructions cause the at least one processor to trigger an alert based on the concavity value.

This provides enhanced privacy protection by dynamically detecting and alerting a user of a malicious message intended to deceive a user into supplying sensitive information based on contexts indicated in the message. Further, a present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the computer program product, generating the template comprises tokenizing the message to generate one or more tokens, tagging the one or more tokens with one or more part-of-speech tags each indicating a part of speech, determining, via a named entity recognition model, one or more recognized entities based on the one or more tokens, and performing pattern matching on the one or more recognized entities to generate the template. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the computer program product, determining that the template is associated with a valid template comprises generating a hash value for the template, and identifying a registered template for the sender that hashes to the hash value and corresponds to a message header of the message to indicate the template is associated with the valid template of the sender. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the computer program product, generating the concavity value comprises extracting one or more sentences from the message based on the one or more part-of-speech tags, comparing the template and the one or more sentences to generate an entity contextual ratio and a task contextual ratio, determining an alignment score indicative of a level of alignment between the template and the message, wherein the alignment score is a ratio of the entity contextual ratio and the task contextual ratio, and determining the concavity value based on the alignment score and an aggregation value for the task contexts of the message. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the computer program product, the entity contextual ratio is a ratio of a first number of entity contexts in the message and a second number of template entity contexts, and the task contextual ratio is a ratio of a first number of task contexts in the message and a second number of template task contexts. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments of the computer program product, the aggregation value represents a number of phrases in the message indicative of one or more tasks expressed by the message. A present invention embodiment leverages task contexts and entity contexts indicated in the message to accurately discern the intent of the message without revealing sensitive information associated with the user. This provides enhanced privacy protection by detecting malicious messages while maintaining the confidentiality of the user.

In embodiments, the named entity recognition model includes a transformer that is iteratively fine-tuned based on a plurality of historical messages and corresponding templates. This provides enhanced privacy protection by producing a template that accurately reflects the content of the message, thus increasing the accuracy of malicious content detection.

In embodiments of the computer program product, the program instructions further cause the at least one processor to determine that a message header indicates consent to receive the message. The at least one processor parses the message to determine that a uniform resource locator (URL) is included in the message. The at least one processor determines that a domain name of the URL matches a list of domain names registered by the sender. This provides enhanced privacy protection by verifying whether the uniform resource locator contained in the message is associated with a trusted sender and detecting malicious content intended to deceive a user into providing sensitive information through a fraudulent uniform resource locator.

In an example scenario, a user may desire to determine whether a message that appears to be from a trusted entity is legitimate. For example, the user may receive a SMS message from a bank providing services to the user. The SMS message appears to be legitimate based on its header information (e.g., name of the bank). The SMS message indicates that the user's bank account has been compromised and immediate action is needed, and further includes a URL that leads to a website requesting the user to input sensitive information (e.g., address, credit card number, etc.) to confirm the user's identity. The user does not want to inadvertently provide sensitive banking information to a malicious actor. An embodiment of the present invention generates a template from the message and determines that the template is associated with a valid template of a sender indicated in the message. The embodiment of the present invention further generates a concavity value to represent an amount of sensitive information requested by the message and triggers an alert based on the concavity value. The concavity value is determined based on differences between task contexts and entity contexts indicated in the message and the template task contexts and template entity contexts. Based on the concavity value, the user is alerted to the malicious message deceiving the user into providing sensitive information, thus preventing privacy or security breaches by a malicious actor.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

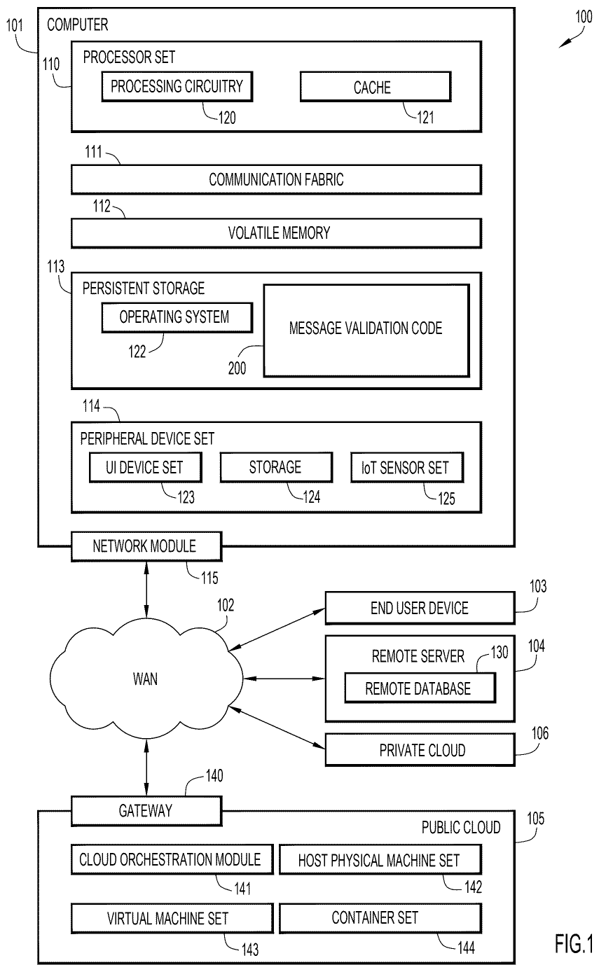

Referring to FIG. 1, computing environment 100 contains an example of an environment for the execution of at least some of the computer code involved in performing the inventive methods, such as message validation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

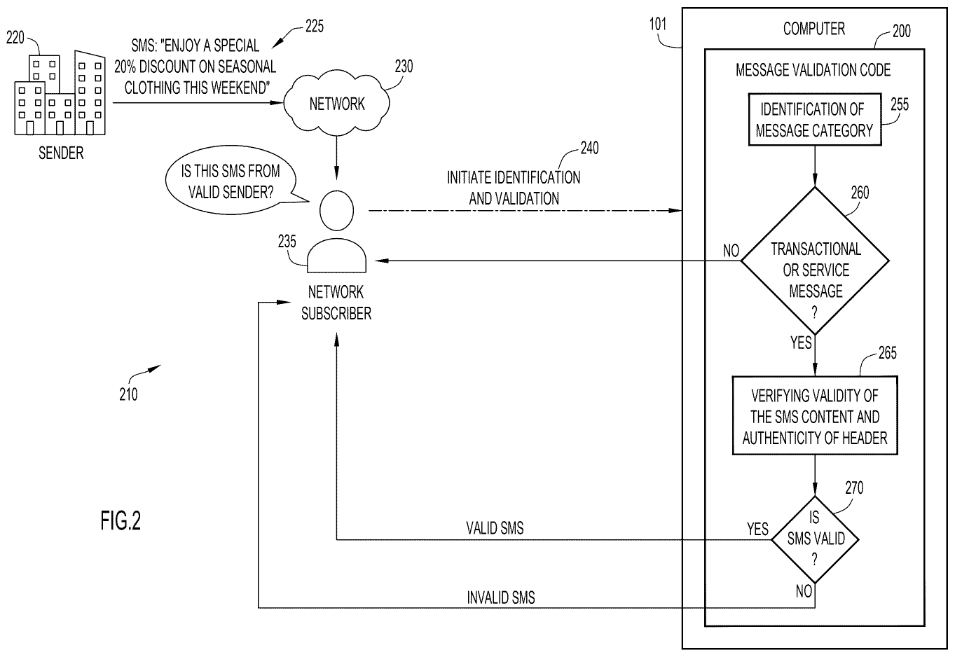

A method 210 of validating a message (e.g., via message validation code 200, computer 101, etc.) according to an embodiment of the present invention is illustrated in FIG. 2. Initially, a message 225 is sent from a sender 220, over a network 230, to a network subscriber 235. Message 225 may be a SMS message, an email, a chat message, or any suitable form of message communication. Content of message 225 may include text, image, video, sound, URL, and/or any content that can be communicated via the network 230. The sender 220 may be any entity, including but not limited to individuals, commercial entities (e.g., retailers, banks, etc.), non-commercial entities (e.g., educational institutions, charities), etc. For example, sender 220 may be a retailer sending a promotional SMS message (e.g., “Enjoy a special 20% discount on seasonal clothing this weekend”) to network subscriber 235.

After message 225 is received at a user device (e.g., user device 103) associated with network subscriber 235, identification and validation of the message 225 are initiated at operation 240 via computer 101 including message validation code 200. The message validation code 200 includes computer code involved in performing operations of identification and validation of message 225. At operation 255, a message category of message 225 is determined. The message category may be determined based on an evaluation of a message header associated with message 225. For example, in a SMS message, the message header may include a name identifying sender 220 (e.g., “XYZ Store”). In an email message, the message header may include the email address and the name of sender 220. Based on the message header, message 225 may be categorized as a personal message or a transaction or service message. Transactional or service messages may be received from commercial or institutional entities (e.g., financial institutions and retailers) that communicate messages related to their products or services to network subscriber 235. Users are often susceptible to fraudulent transactional or service messages from apparent trusted commercial or institutional entities, known as “smishing” (for text messages) and “phishing” (for emails). Thus, it is important to identify the category of message 225 prior to validating its authenticity.

The identified message category is evaluated at operation 260. When message 225 is a personal message, the message category is reported to network subscriber 235. However, when message 225 is a transactional or service message, the validity of the content in message 225 and the authenticity of the message header are verified at operation 265. Further details of the message validation and header authentication is described below. The validity of message 225 is reported to network subscriber 235 at operation 270. When message 225 contains non-malicious content from a verified sender, message 225 is reported as a valid message to network subscriber 235. However, when message 225 contains malicious content, message 225 is reported as invalid to network subscriber 235.

The network 230 may include any wide area network (WAN) (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

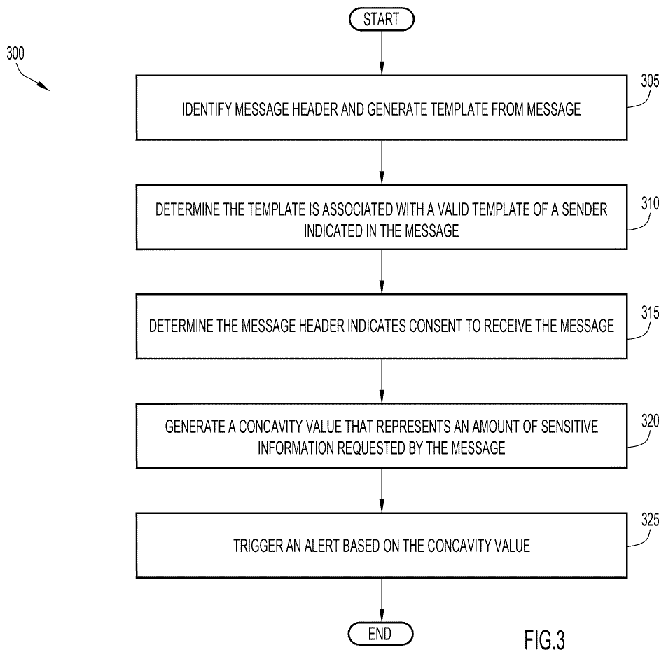

A method 300 of validating the content of a message (e.g., via message validation code 200, computer 101, etc.) according to an embodiment of the present invention is illustrated in FIG. 3. Initially, a message header of a message is identified and a template of the message is generated at operation 305 in substantially the same manner described below. The template is determined to be associated with a valid template of a sender indicated in the message at operation 310. For example, the template may be compared with a list of valid templates associated with the sender to determine whether the template is a valid template.

The message header is evaluated to determine whether the header indicates a user has consented to receive the message at operation 315. For example, a SMS scrubbing service may be used to determine if the user is in a list of subscribers consented to receive messages from a specific entity identified in the message header. After user consent has been verified, a concavity value is generated at operation 320. The concavity value represents an amount of sensitive information requested by the message. For example, the message may include words and/or phrases that indicate a request for the user to provide sensitive information such as passwords, account details, personal information, etc. The concavity value may be determined based on a comparison between the template and the message in substantially the same manner described below. Based on concavity value, an alert is triggered at operation 325. For example, a concavity value greater than a predetermined threshold indicates a significant amount of sensitive information is requested by the message, and the user is alerted that the trust level of the message is low. The user may also be alerted to potential privacy or security breaches associated with the content of the message (e.g., a malicious URL leading to scams and attacks).

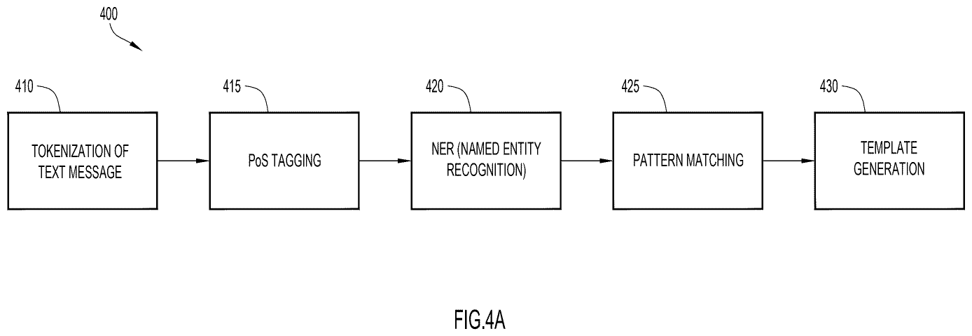

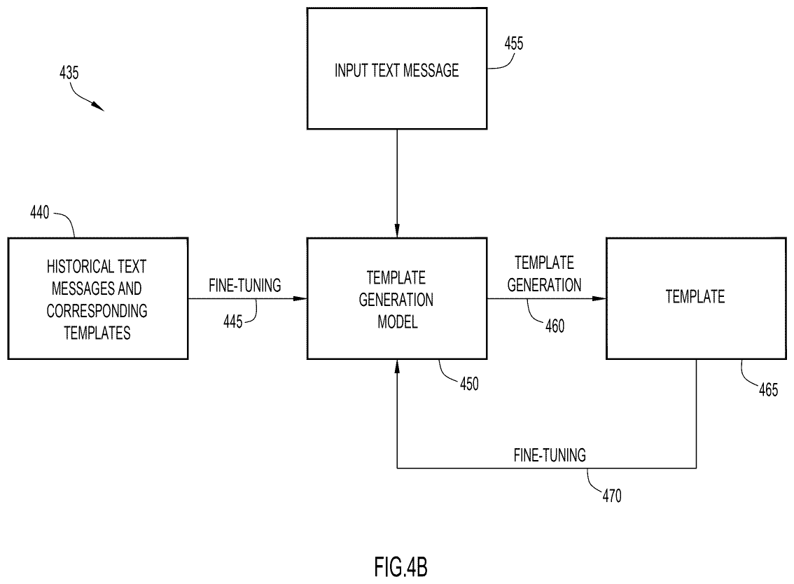

A method 400 of generating a template from a message (e.g., via message validation code 200, computer 101, etc.) according to an embodiment of the present invention is illustrated in FIG. 4A. The message, including one or more input texts, is tokenized to generate one or more tokens at operation 410. The message is parsed into tokens (e.g., words, n-grams, etc.) via a text tokenizer, which may be implemented by any conventional or other natural language processing (NLP) component or tokenizer producing any types of tokens and/or identifiers from text. The tokens may include any quantity of any units of text (e.g., words, n-grams, etc.), and be associated with any vocabulary (e.g., words, phrases, any natural language, etc.).

The one or more tokens are tagged with one or more part-of-speech (POS) tags each indicating a part of speech at operation 415. Each of the one or more tokens is tagged with a part-of-speech (e.g., noun, verb, etc.) via a POS tagger, which may be implemented by any conventional or other NLP component or tagger producing POS tags for tokens. For example, the POS tagger may be implemented via neural networks, Naïve Bayes models, hidden Markov models, or any other machine learning or NLP algorithm/model capable of producing POS tags.

One or more recognized entities in the message are identified based on the one or more tokens and their corresponding POS tags via a named entity recognition (NER) model at operation 420. One or more tokens representing entities in the text are classified, via the NER model, into corresponding categories (e.g., names of people, places, dates, etc.). For example, for the message “Store A is having a sale on Saturday,” the token “Store A” is classified as a business or place and “Saturday” is classified as a time or date. The NER model may include any machine learning or NLP algorithm/model capable of identifying and categorizing entities in text. For example, the NER model may include a transformer model, such as a bidirectional encoder representations from transformers (BERT) model or a Robustly Optimized BERT Approach (RoBERTa) model. The NER model may be a pre-trained model that can be applied to identify entities in the message and iteratively fine-tuned based on a plurality of historical messages and corresponding templates. For example, in order for the NER model to accurately recognize entities in a promotional message, the NER model may be fine-tuned based on historical promotional messages sent by various businesses or service providers and corresponding templates. The historical promotional messages may include entities that reflect discounts, products, timeframes, deadlines, etc.

Pattern matching is performed on the one or more recognized entities at operation 425. Pattern matching may be implemented by any conventional or other NLP component or technique configured to identify patterns in text. For example, pattern matching may include keyword matching, regular expression matching, machine-learning based matching, etc. The message (e.g., input text) is converted into a templated format to generate a template via a template generation model at operation 430. For example, the template generation model may include a Text-to-Text Transformer (T5) model trained based on a plurality of message-template pairs to convert the input text to a template. The template generation model may be fine-tuned based on a plurality of historical message-template pairs to generate a template for the message (e.g., a promotional message).

A method 435 of fine-tuning a template generation model (e.g., via message validation code 200, computer 101, etc.) according to an embodiment of the present invention is illustrated in FIG. 4B. Initially, historical text messages and corresponding templates 440 serve as inputs to fine-tune a template generation model 450 at a fine-tuning operation 445. The template generation model 450 may be implemented by a transformer model (e.g., T5 model) or any conventional or other NLP component configured to generate a template from input text. After template generation model 450 is fine-tuned, an input text message 455 is input to template generation model 450 to generate a template 465 that corresponds to the input text message 455 at a template generation operation 460. The template 465 is input to template generation model 450 at a fine-tuning operation 470 to further adjust template generation model 450 to generate a template that accurately reflects input text message 455. The template generation operation 460 and fine-tuning operation 470 may proceed iteratively until a stopping criterion is met. The stopping criterion may be based on model performance, number of iterations, or any suitable criterion defined and/or configured by a user.

The NLP components/techniques configured to implement various operations illustrated in FIG. 4A and FIG. 4B may include various techniques (e.g., entity recognition, relationship discovery, semantic analysis, sentiment analysis, part-of-speech (POS) tagging, etc.). The machine learning models may include any conventional or other machine learning models (e.g., mathematical/statistical, classifiers, feed-forward, recurrent, convolutional, deep learning, or other neural networks, large language models (LLM), etc.). For example, neural networks may include an input layer, one or more intermediate layers (e.g., including any hidden layers), and an output layer. Each layer includes one or more neurons, where the input layer neurons receive input, and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various example data as input and corresponding desired outputs, where the neural network attempts to produce the provided output and uses an error from the output (e.g., difference between produced and known outputs) to adjust weight (and bias) values (e.g., via backpropagation or other training techniques).

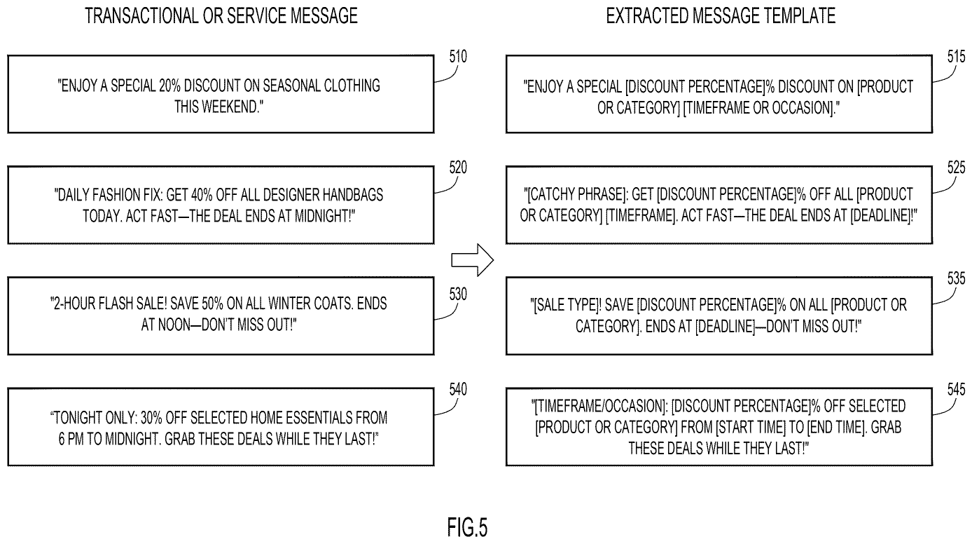

Example message-template pairs for transactional or service messages generated according to an embodiment of the present invention are illustrated in FIG. 5. As described above, transactional or service messages may be sent by commercial or institutional entities (e.g., financial institutions, telecommunication service providers, retail entities, advertising services, etc.) that communicate messages related to products or services. Additionally or alternatively, transactional or service messages may be from third-party entities that send messages on behalf of commercial or institutional entities. In accordance with methods of template generation described above (e.g., method 400 and method 435), a plurality of message-template pairs may be generated for transactional or service messages.

For example, a message 510 “Enjoy a special 20% discount on seasonal clothing this weekend.” may be sent by a retailer or a third-party service associated with the retailer to inform subscribers identified in a subscriber list of discounts taking place at a specific timeframe. The message 510, via methods described above, is converted into a message template 515 “Enjoy a special [discount percentage]% discount on [product or category] [timeframe or occasion].” that reflects patterns identified in the message 510. Additional examples of transactional or service message-template pairs include message 520 “Daily Fashion Fix: Get 40% off all designer handbags today. Act fast—the deal ends at midnight! ” and message template 525 “[Catchy Phrase]: Get [discount percentage]% off all [product or category] [timeframe]. Act fast—the deal ends at [deadline]!”; message 530 “2-Hour Flash Sale! Save 50% on all winter coats. Ends at noon—don't miss out!” and template 535 “[Sale Type]! Save [discount percentage]% on all [product or category]. Ends at [deadline]—don't miss out!”; message 540 “Tonight Only: 30% off selected home essentials from 6 PM to midnight. Grab these deals while they last!” and template 545 “[Timeframe/Occasion]: [discount percentage]% off selected [product or category] from [start time] to [end time]. Grab these deals while they last!”

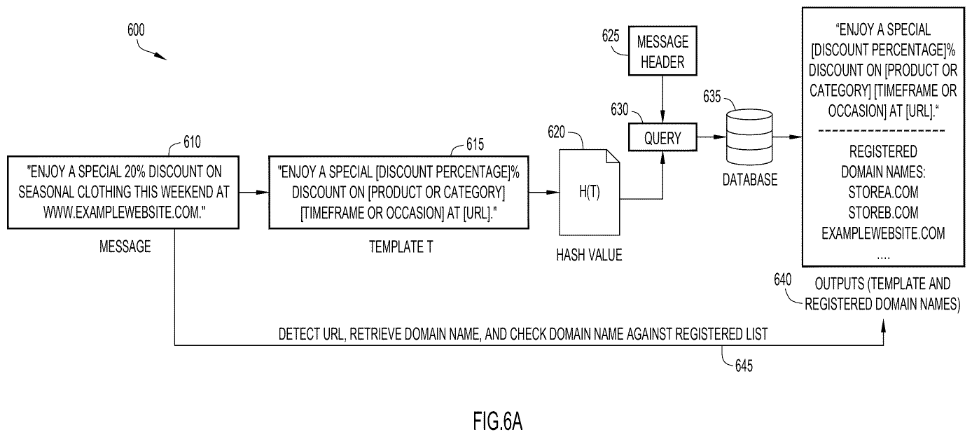

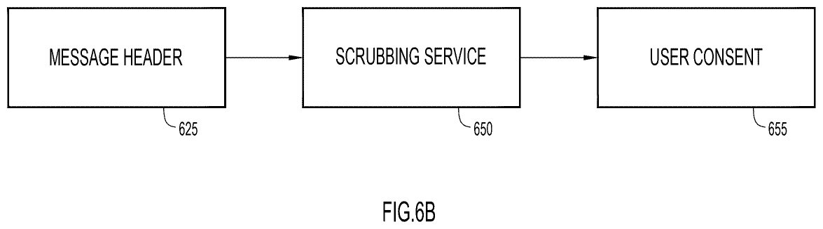

A method 600 of validating a message containing a URL (e.g., via message validation code 200, computer 101, etc.) according to an embodiment of the present invention is illustrated in FIG. 6A. A message 610 is converted to a template T 615 in accordance with methods of template generation described above (e.g., method 400 and method 435). For example, message 610 “Enjoy a special 20% discount on seasonal clothing this weekend at www.examplewebsite.com.” may be a transactional or service message containing a URL that is converted to template T 615 “Enjoy a special [discount percentage]% discount on [product or category] [timeframe or occasion] at [URL].” A hash value 620 of template T 615 is generated via a hash function/algorithm. The hash function/algorithm may be implemented by any conventional techniques that map input data to fixed-size outputs (e.g., hash values) that can be used to index a hash table.

The hash value 620 and a message header 625 associated with message 610 together form a query 630. For example, message header 625 may be a string including the name of a sender of message 610. The query 630 is used by a telecommunication service provider (TSP) or other entity associated with the sender of message 610 to validate message 610. In certain embodiments, identity of the TSP associated with the sender may be determined by querying a master database. For example, the TSP may be a mobile wireless telecommunication company providing short message service (SMS). In order to validate message 610, query 630 may be made, by the TSP, to a database 635 storing a plurality of registered templates associated with respective message headers. When query 630 is successful, outputs 640 returned by database 635 may include a template that hashes to hash value 620 and a list of registered domain names registered by the sender of message 610. The returned template in outputs 640 may be validated by a subscriber service through which the sender sends message 610 to a list of subscribers.

In certain embodiments, message 610 may include text indicating a URL. Upon receiving outputs 640, message 610 is parsed to detect a URL and retrieve a domain name of the URL. The retrieved domain name is compared to the list of registered domain names in outputs 640 at operation 645. For example, the URL “www.examplewebsite.com” may be detected in message 610 “Enjoy a special 20% discount on seasonal clothing this weekend at examplewebsite.com.” The domain name “examplewebsite.com” is extracted from the URL and compared to the list of registered domain names in outputs 640. When the domain name matches a domain name in the list of registered domain names, message 610 and the URL are both validated as being from a trusted sender.

A manner of verifying user consent for receiving a message from a sender (e.g., via message validation code 200, computer 101, etc.) according to an embodiment of the present invention is illustrated in FIG. 6B. A message header 625 is extracted from a message (e.g., email, text message, etc.). As described above, message header 625 may include a string with identifying information (e.g., name) of the sender. Connection with a scrubbing service is initiated to verify whether a user (e.g., recipient of message) has consented to receiving messages from the sender at operation 650. A scrubbing service is configured to match the sender's data extracted from the message header with those associated with a list of senders for which a user has provided consent to verify user consent for the message at operation 655. In certain embodiments, when the message is detected to contain a URL, the domain name of the URL is compared to a list of domain names registered by the sender to verify user consent.

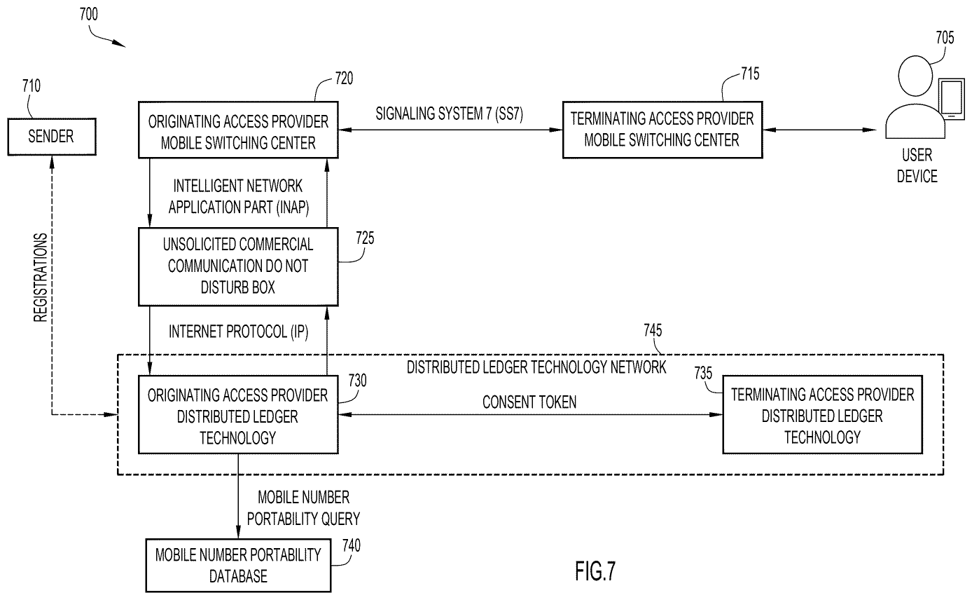

A system 700 for verifying user consent for receiving a SMS message from a sender (e.g., via message validation code 200, computer 101, etc.) according to an embodiment of the present invention is illustrated in FIG. 7. The system 700 includes a user device 705 (e.g., end user device 103) configured to receive one or more SMS messages from a sender 710, a terminating access provider mobile switching center 715, an originating access provider mobile switching center 720, an unsolicited commercial communication do not disturb box 725, a distributed ledger technology network 745 including an originating access provider distributed ledger technology 730 and a terminating access provider distributed ledger technology 735, and a mobile number portability database 740.

The sender 710 may be any entity, including but not limited to individuals, commercial entities (e.g., retailers, banks, etc.), non-commercial entities (e.g., educational institutions, charities), etc. The user device 705 may be a message recipient connected to a digital mobile network through a terminating access provider (e.g., telecommunication service provider for user device 705). The terminating access provider mobile switching center 715 is configured to perform call management, SMS routing, and/or conference call routing for user device 705. When a message is sent from sender 710 to user device 705, terminating access provider mobile switching center 715 is configured to communicate with originating access provider mobile switching center 720 via the Signaling System No. 7 (SS7) protocol or any other suitable telephony signaling protocol. The originating access provider mobile switching center 720 is configured to perform call management, SMS routing, and/or conference call routing for an originating access provider, such as a telecommunication service provider for sender 710.

The originating access provider mobile switching center 720 associated with sender 710 is configured to contact an unsolicited commercial communication do not disturb box 725 to check whether user device 705 is registered with a do-not-disturb service that blocks promotional messages and calls for users. The originating access provider mobile switching center 720 may communicate with unsolicited commercial communication do not disturb box 725 via the intelligent network application part (INAP) protocol or any suitable telephony signaling protocol. When user device 705 is not registered with a do-not-disturb service, then unsolicited commercial communication do not disturb box 725 is configured to send a Mobile Station International Subscriber Directory Number (MSISDN) associated with sender 710 to originating access provider distributed ledger technology 730 via Internet Protocol (IP).

The sender 710 is registered with originating access provider distributed ledger technology 730, which is configured to maintain a distributed ledger for storing consent acquired by sender 710 (message originator). The originating access provider distributed ledger technology 730 is configured to make a mobile number portability query to mobile number portability database 740 to determine the network operator servicing the MSISDN associated with sender 710. The originating access provider distributed ledger technology 730 may provide information on whether user device 705 (message recipient) has already provided consent for receiving messages from sender 710. When user device 705 has already provided consent, originating access provider distributed ledger technology 730 reports that consent verification is complete. When user device 705 has not already provided consent, originating access provider distributed ledger technology 730 requests and retrieves a consent token from terminating access provider distributed ledger technology 735. The consent token represents consent provided by user device 705 to receive messages from sender 710. The originating access provider distributed ledger technology 730 and terminating access provider distributed ledger technology 735 together form distributed ledger technology network 745, which is configured to maintain consent information associated with user devices within a network. Once the consent token is retrieved, originating access provider distributed ledger technology 730 may report that user device 705 has provided consent to receive the message from sender 710.

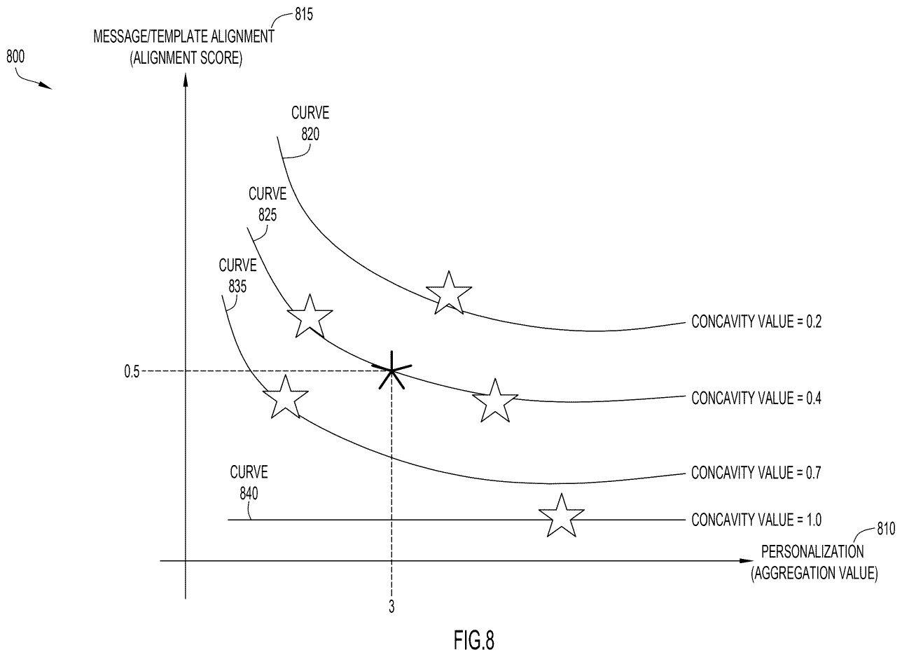

A graph 800 for determining a concavity value for a message (e.g., via message validation code 200, computer 101, etc.) according to an embodiment of the present invention is illustrated in FIG. 8. When a message is received, a concavity value representing an amount of sensitive information requested by the message may be determined via graph 800. The graph 800 includes an x-axis representing an aggregation value 810 and a y-axis representing an alignment score 815. The aggregation value 810 represents an amount of personalization detected in the content of the message. The alignment score 815 represents a level of alignment between the message and a validated template (e.g., validated template in outputs 640).

Initially, the message may be parsed to obtain one or more POS tags as described above. One or more sentences may be extracted from the message based on the one or more POS tags. The one or more sentences are further processed to extract core sentences (e.g., sentences represented by the {subject, verb, object} format) to obtain phrase-level context information about the message. For example, sentences extracted from the message “Don't miss your transaction alerts, account statements, personalized offers and more. Update your latest contact details with bank by logging into your online card account at https://www.something.com/card/login” may be processed to generate the following representations of core sentences: “{(transaction alerts, account statements), (personalized), (offers)}” and “{(Update contact details), (logging), (online card account)}.” The core sentences and the remaining words in the sentence are analyzed to obtain the phrase-level context information, which includes an entity context and a task context.

Entity context is determined based on words and/or phrases in a sentence that identify an entity (e.g., a person), or in other words, the “who” of the sentence. For example, phrases that include a pronoun or a name, such as “(your transactions, account statements), (your contact detail), (your card account)” represent the entity context of a sentence. Task context is determined based on words and/or phrases in a sentence that identify a task, or in other words, the “what” of the sentence. For example, phrases that identify a task may include “(personalized offers and more), (latest details), (logging to online account).” The entity context and task context may be determined by conventional techniques (e.g., natural language processing models/algorithms).

An entity contextual ratio for the message is determined via a comparison between the entity context of the message and the entity context of the template. The entity contextual ratio is a ratio of a first number of entity contexts in the message and a second number of entity contexts in the template (or template entity contexts). For example, when the message and the template contain the same count of entity contexts, E, the entity contextual ratio is E/E=1. When the message contains one entity while the template contains two entities, the entity contextual ratio is 1/2=0.5. The entity contextual ratio measures a level of entity contextual alignment between the message and the template based on entity counts.

A task contextual ratio for the message is determined via a comparison between the task context of the message and the task context of the template. The task contextual ratio is a ratio of a first number of task contexts in the message and a second number of task contexts in the template (or template task contexts). For example, when the message and the template contain the same count of task contexts, T, the task contextual ratio is T/T=1. When the message contains two tasks while the template contains one task, the task contextual ratio is 2/1=2. The task contextual ratio measures a level of task contextual alignment between the message and the template based on task counts.

The aggregation value 810 represents a number of words and/or phrases in the message indicative of one or more tasks expressed by the message. For example, if the message contains three phrases each representing a task, the aggregation value 810 for the message would be 3. The alignment score 815, indicative of a level of alignment between the template and the message, is a ratio of the entity contextual ratio and the task contextual ratio. For example, when an entity contextual ratio is 1 (e.g., indicating the message and the template contain the same count of entities) and a task contextual ratio is 2 (e.g., indicating the message contains more tasks than the template), the alignment score 815 for the message would be 1/2=0.5.

The aggregation value 810 and alignment score 815 for the message serve as coordinates and are applied to graph 800 to determine a corresponding concavity value. The graph 800 includes a plurality of curves, each corresponding to a different concavity value. For example, graph 800 includes a curve 820 with a concavity value of 0.2, a curve 825 with a concavity value of 0.4, a curve 835 with a concavity value of 0.7, and a curve 840 with a concavity of 1.0. Graph 800 may include any quantity of curves representing various concavity values. The number of curves as well as the shape of the curves and their corresponding concavity values are configurable by a user.

By way of example, when the aggregation value 810 for the message is 3 and alignment score 815 for the message is 0.5, the intersection of the two values falls on curve 825 on graph 800. Curve 825 has a corresponding concavity value of 0.4. Thus, the concavity value for the message is 0.4. The higher the concavity value, the greater the difference between the message and the template, and the greater amount of sensitive information is requested by the message. When the concavity value is greater than a threshold value, an alert may be generated to notify a user the message has a low trust level and may be suspicious or fraudulent. The threshold value may be predetermined or dynamically adjusted by a user.

One or more mitigation actions may be performed in response to the concavity value exceeding a threshold value. For example, the message may be blocked (e.g., by a telecommunication service provider or other entity) to prevent the delivery of the message, and subsequent messages from the same sender and/or containing the same message header may be blocked. Another mitigation action includes altering the message to remove the malicious content prior to re-delivery of the message. For example, a malicious URL in the message may be replaced with a URL associated with a trusted source, such as a URL leading to a website where the user may report the fraudulent communication. The altered message, accompanied by an explanation that malicious content has been removed, may be delivered to the user. Moreover, another mitigation action includes delivering the message without alteration, but includes a warning that the message likely contains malicious content. Upon detecting a malicious content warning, one or more security software applications (e.g., antivirus software) installed on a user device where the message is received may be automatically triggered to perform a scan of the message and/or attachments. Further, upon detecting the user has clicked on malicious content (e.g., URL) that triggers a connection to a content server, the user device may terminate the connection to prevent one or more software applications (e.g., web browsers) from rendering and/or displaying additional malicious content (e.g., webpages associated with the malicious URL). These mitigation actions provide enhanced privacy protection by alerting users of malicious messages and preventing users from inadvertently accessing malicious content that exposes users to privacy or security breaches.

Present invention embodiments provide various technical and other advantages. For example, the present invention embodiments provide enhanced privacy protection by dynamically detecting and alerting a user of a malicious message intended to deceive a user into supplying sensitive information based on contexts indicated in the message. Further, present invention embodiments leverage task contexts and entity contexts indicated in the message to accurately discern the intent of the message. This provides dynamic detection of malicious content in a message without revealing the content of the message, which may include sensitive information associated with the user. Thus, the present invention embodiments provide enhanced privacy protection by detecting malicious messages while maintaining the confidentiality of the user. Moreover, detected malicious messages may be blocked or altered in real time, thus preventing users from inadvertently accessing malicious content that leads to scams and attacks.

It will be appreciated that the embodiments described above and illustrated in the drawings represent only a few of the many ways of implementing embodiments for communication security via context-based message validation and malicious content detection.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., message validation code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., messages, message validation results, templates, alerts, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., messages, message validation results, templates, alerts, etc.).

The present invention embodiments are not limited to the specific tasks or algorithms described above, but may be utilized for validating any types of messages from any data sources.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of validating a message comprising:
generating, via at least one processor, a template from the message, wherein the message is received over a network and the template indicates template task contexts and template entity contexts;
determining, via the at least one processor, that the template is associated with a valid template of a sender indicated in the message;
generating, via the at least one processor, a concavity value based on differences between task contexts and entity contexts indicated in the message and the template task contexts and template entity contexts, wherein the concavity value represents an amount of sensitive information requested by the message; and
triggering, via the at least one processor, an alert based on the concavity value.

2. The method of claim 1, wherein generating the template comprises:
tokenizing the message to generate one or more tokens;
tagging the one or more tokens with one or more part-of-speech tags each indicating a part of speech;
determining, via a named entity recognition model, one or more recognized entities based on the one or more tokens; and
performing pattern matching on the one or more recognized entities to generate the template.

3. The method of claim 1, wherein determining that the template is associated with a valid template comprises:
generating a hash value for the template; and
identifying a registered template for the sender that hashes to the hash value and corresponds to a message header of the message to indicate the template is associated with the valid template of the sender.

4. The method of claim 2, wherein generating the concavity value comprises:
extracting one or more sentences from the message based on the one or more part-of-speech tags;
comparing the template and the one or more sentences to generate an entity contextual ratio and a task contextual ratio;
determining an alignment score indicative of a level of alignment between the template and the message, wherein the alignment score is a ratio of the entity contextual ratio and the task contextual ratio; and
determining the concavity value based on the alignment score and an aggregation value for the task contexts of the message.

5. The method of claim 4, wherein the entity contextual ratio is a ratio of a first number of entity contexts in the message and a second number of template entity contexts, and wherein the task contextual ratio is a ratio of a first number of task contexts in the message and a second number of template task contexts.

6. The method of claim 4, wherein the aggregation value represents a number of phrases in the message indicative of one or more tasks expressed by the message.

7. The method of claim 2, wherein the named entity recognition model includes a transformer that is iteratively fine-tuned based on a plurality of historical messages and corresponding templates.

8. The method of claim 1, further comprising:
determining, via the at least one processor, that a message header indicates consent to receive the message;
parsing, via the at least one processor, the message to determine that a uniform resource locator (URL) is included in the message; and
determining, via the at least one processor, that a domain name of the URL matches a list of domain names registered by the sender.

9. The method of claim 1, wherein the message includes a short message service text message received at a mobile device.

10. A system for validating a message comprising:
one or more memories; and
at least one processor coupled to the one or more memories, and configured to:
generate a template from the message, wherein the message is received over a network and the template indicates template task contexts and template entity contexts;
determine that the template is associated with a valid template of a sender indicated in the message;
generate a concavity value based on differences between task contexts and entity contexts indicated in the message and the template task contexts and template entity contexts, wherein the concavity value represents an amount of sensitive information requested by the message; and
trigger an alert based on the concavity value.

11. The system of claim 10, wherein generating the template comprises:
tokenizing the message to generate one or more tokens;
tagging the one or more tokens with one or more part-of-speech tags each indicating a part of speech;
determining, via a named entity recognition model, one or more recognized entities based on the one or more tokens; and
performing pattern matching on the one or more recognized entities to generate the template.

12. The system of claim 10, wherein determining that the template is associated with a valid template comprises:
generating a hash value for the template; and
identifying a registered template for the sender that hashes to the hash value and corresponds to a message header of the message to indicate the template is associated with the valid template of the sender.

13. The system of claim 11, wherein generating the concavity value comprises:
extracting one or more sentences from the message based on the one or more part-of-speech tags;
comparing the template and the one or more sentences to generate an entity contextual ratio and a task contextual ratio;
determining an alignment score indicative of a level of alignment between the template and the message, wherein the alignment score is a ratio of the entity contextual ratio and the task contextual ratio; and
determining the concavity value based on the alignment score and an aggregation value for the task contexts of the message.

14. The system of claim 13, wherein the entity contextual ratio is a ratio of a first number of entity contexts in the message and a second number of template entity contexts, and wherein the task contextual ratio is a ratio of a first number of task contexts in the message and a second number of template task contexts.

15. The system of claim 13, wherein the aggregation value represents a number of phrases in the message indicative of one or more tasks expressed by the message.

16. The system of claim 11, wherein the named entity recognition model includes a transformer that is iteratively fine-tuned based on a plurality of historical messages and corresponding templates.

17. The system of claim 10, wherein the at least one processor is further configured to:
determine that a message header indicates consent to receive the message;
parse the message to determine that a uniform resource locator (URL) is included in the message; and
determine that a domain name of the URL matches a list of domain names registered by the sender.

18. A computer program product for validating a message, the computer program product comprising one or more computer readable storage media having program instructions collectively stored on the one or more computer readable storage media, the program instructions executable by at least one processor to cause the at least one processor to:
generate a template from the message, wherein the message is received over a network and the template indicates template task contexts and template entity contexts;
determine that the template is associated with a valid template of a sender indicated in the message;
generate a concavity value based on differences between task contexts and entity contexts indicated in the message and the template task contexts and template entity contexts, wherein the concavity value represents an amount of sensitive information requested by the message; and
trigger an alert based on the concavity value.

19. The computer program product of claim 18, wherein generating the template comprises:
tokenizing the message to generate one or more tokens;
tagging the one or more tokens with one or more part-of-speech tags each indicating a part of speech;
determining, via a named entity recognition model, one or more recognized entities based on the one or more tokens; and
performing pattern matching on the one or more recognized entities to generate the template.

20. The computer program product of claim 18, wherein determining that the template is associated with a valid template comprises:
generating a hash value for the template; and
identifying a registered template for the sender that hashes to the hash value and corresponds to a message header of the message to indicate the template is associated with the valid template of the sender.

21. The computer program product of claim 19, wherein generating the concavity value comprises:
extracting one or more sentences from the message based on the one or more part-of-speech tags;
comparing the template and the one or more sentences to generate an entity contextual ratio and a task contextual ratio;
determining an alignment score indicative of a level of alignment between the template and the message, wherein the alignment score is a ratio of the entity contextual ratio and the task contextual ratio; and
determining the concavity value based on the alignment score and an aggregation value for the task contexts of the message.

22. The computer program product of claim 21, wherein the entity contextual ratio is a ratio of a first number of entity contexts in the message and a second number of template entity contexts, and wherein the task contextual ratio is a ratio of a first number of task contexts in the message and a second number of template task contexts.

23. The computer program product of claim 21, wherein the aggregation value represents a number of phrases in the message indicative of one or more tasks expressed by the message.

24. The computer program product of claim 19, wherein the named entity recognition model includes a transformer that is iteratively fine-tuned based on a plurality of historical messages and corresponding templates.

25. The computer program product of claim 18, wherein the program instructions further cause the at least one processor to:
determine that a message header indicates consent to receive the message;
parse the message to determine that a uniform resource locator (URL) is included in the message; and
determine that a domain name of the URL matches a list of domain names registered by the sender.
